(19) United States
(12) Patent Application Publication
(10) Pub. No.: US 2024/0306004 A1
(43) Pub. Date: Sep. 12, 2024

(54) Beam Management for High-Speed Train

(71) Applicant: Apple Inc., Cupertino, CA (US)

(72) Inventors: Huaning NIU, San Jose, CA (US); Dawei ZHANG, Saratoga, CA (US); Yang TANG, San Jose, CA (US); Jie CUI, San Jose, CA (US); Manasa RAGHAVAN, Sunnyvale, CA (US); Qiming LI, Beijing (CN); Xiang CHEN, Campbell, CA (US); Yushu ZHANG, Beijing (CN)

(21) Appl. No.: 18/261,385

(22) PCT Filed: May 31, 2021
(86) PCT No.: PCT/CN2021/097368

§ 371 Date: Jul. 13, 2023

(30) Foreign Application Priority Data
Jan. 15, 2021 (WO) PCT/CN2021/072163

(51) Int. Cl. H04W 16/28; H04L 5/00; H04W 8/22; H04W 76/28; H04W 84/00

(52) U.S. Cl. CPC H04W 16/28; H04L 5/0051; H04W 8/22; H04W 76/28; H04W 84/005

(57) ABSTRACT

Embodiments of the present disclosure relate to devices, methods, apparatuses and computer readable storage media for beam failure management, and in particular for beam management for high-speed train (HST) in Frequency Range 2 (FR2). According to embodiments of the present disclosure, a terminal device receives from a network device a configuration concerning a high-speed mode of the terminal device, the terminal device determines a reduced evaluation period for beam management in the high-speed mode based on the configuration. The reduced evaluation period determined by the terminal device is shorter than an evaluation period in a non-high-speed mode. Then, the terminal device performs the beam management using the reduced evaluation period.

### FIELD

Embodiments of the present disclosure generally relate to the field of telecommunication and in particular, to methods, devices, apparatuses and computer readable storage media for beam management.

### BACKGROUND

New radio access system, which is also called NR system or NR network, is the next generation communication system. In NR system, user equipment (UE) and a next generation NodeB (gNB) can communicate via a plurality of beams. To this end, beam management at the UE is needed. The beam management is a mechanism for detecting beam failures of the UE and recovering beams when all or part of beams serving the UE has failed. Moreover, the UE may operate in a high-speed scenario, for example, the UE may be located on a high-speed train (HST). In such a high-speed scenario, the beam management at the UE needs to be enhanced.

### SUMMARY

In general, example embodiments of the present disclosure provide a solution for beam management.

In a first aspect, there is provided a method. The method comprises receiving, at a terminal device from a network device, a configuration concerning a high-speed mode of the terminal device; determining a reduced evaluation period for beam management in the high-speed mode based on the configuration, the reduced evaluation period shorter than an evaluation period in a non-high-speed mode; and performing the beam management using the reduced evaluation period.

In a second aspect, there is provided a method. The method comprises determining, at a network device, a configuration concerning beam management of a terminal device in a high-speed mode; and transmitting the configuration to the terminal device, such that the beam management in the high-speed mode is performed by the terminal device using a reduced evaluation period determined based on the configuration, the reduced evaluation period shorter than an evaluation period in a non-high-speed mode.

In a third aspect, there is provided a terminal device. The terminal device comprises at least one processor and at least one memory including computer program codes. The at least one memory and the computer program codes are configured to, with the at least one processor, cause the terminal device to, receive, from a network device, a configuration concerning a high-speed mode of the terminal device; determine a reduced evaluation period for beam management in the high-speed mode based on the configuration, the reduced evaluation period shorter than an evaluation period in a non-high-speed mode; and perform the beam management using the reduced evaluation period.

In a fourth aspect, there is provided a network device. The network device comprises at least one processor and at least one memory including computer program codes. The at least one memory and the computer program codes are configured to, with the at least one processor, cause the network device to, determine a configuration concerning beam management of a terminal device in a high-speed mode; and transmit the configuration to the terminal device, such that the beam management in the high-speed mode is performed by the terminal device using a reduced evaluation period determined based on the configuration, the reduced evaluation period shorter than an evaluation period in a non-high-speed mode.

In a fifth aspect, there is provided an apparatus. The apparatus comprises means for receiving, at a terminal device from a network device, a configuration concerning a high-speed mode of the terminal device; means for determining a reduced evaluation period for beam management in the high-speed mode based on the configuration, the reduced evaluation period shorter than an evaluation period in a non-high-speed mode; and means for performing the beam management using the reduced evaluation period.

In a sixth aspect, there is provided an apparatus. The apparatus comprises means for determining, at a network device, a configuration concerning beam management of a terminal device in a high-speed mode; and means for transmitting the configuration to the terminal device, such that the beam management in the high-speed mode is performed by the terminal device using a reduced evaluation period determined based on the configuration, the reduced evaluation period shorter than an evaluation period in a non-high-speed mode.

In a seventh aspect, there is provided a computer readable storage medium comprising program instructions stored thereon. The instructions, when executed by an apparatus, cause the apparatus to perform the method according to the above first aspect.

In an eighth aspect, there is provided a computer readable storage medium comprising program instructions stored thereon. The instructions, when executed by an apparatus, cause the apparatus to perform the method according to the above second aspect.

In a ninth aspect, there is provided a computer program product that is stored on a computer readable medium and includes machine-executable instructions. The machine-executable instructions, when being executed, cause a machine to perform the method according to the above first aspect.

In a tenth aspect, there is provided a computer program product that is stored on a computer readable medium and includes machine-executable instructions. The machine-executable instructions, when being executed, cause a machine to perform the method according to the above second aspect.

In an eleventh aspect, there is provided a baseband processor of a terminal device. The baseband processor is configured to perform the method according to the above first aspect.

In a twelfth aspect, there is provided a baseband processor of a network device. The baseband processor is configured to perform the method according to the above second aspect.

It is to be understood that the summary section is not intended to identify key or essential features of embodiments of the present disclosure, nor is it intended to be used to limit the scope of the present disclosure. Other features of the present disclosure will become easily comprehensible through the following description.

### BRIEF DESCRIPTION OF THE DRAWINGS

Some example embodiments will now be described with reference to the accompanying drawings, wherein:

FIG. 1A illustrates an example deployment of a UE mounted on HST in Frequency Range 2 (FR2) network;

FIG. 1B illustrates another example deployment of a UE mounted on HST in FR2 network;

FIG. 2 illustrates an example communication network in which embodiments of the present disclosure may be implemented;

FIG. 3 illustrates a flowchart illustrating an example process for beam management according to some embodiments of the present disclosure;

FIG. 4 shows a schematic diagram illustrating an example parallel beam failure detection (BFD) and candidate beam detection (CBD) operations according to some embodiments of the present disclosure;

FIG. 5A illustrates a schematic diagram illustrating an example RS configuration for CBD according to some embodiments of the present disclosure;

FIG. 5B illustrates another schematic diagram illustrating an example RS configuration for CBD according to some embodiments of the present disclosure;

FIG. 6 illustrates a flowchart of an example method of beam management performed by a terminal device according to some embodiments of the present disclosure;

FIG. 7 illustrates a flowchart of an example method of beam management configuration performed by a network device according to some embodiments of the present disclosure; and

FIG. 8 illustrates a simplified block diagram of an apparatus that is suitable for implementing embodiments of the present disclosure.

Throughout the drawings, the same or similar reference numerals represent the same or similar element.

### DETAILED DESCRIPTION

Principle of the present disclosure will now be described with reference to some embodiments. It is to be understood that these embodiments are described only for the purpose of illustration and help those skilled in the art to understand and implement the present disclosure, without suggesting any limitation as to the scope of the disclosure. The disclosure described herein can be implemented in various manners other than the ones described below.

In the following description and claims, unless defined otherwise, all technical and scientific terms used herein have the same meaning as commonly understood by one of ordinary skills in the art to which this disclosure belongs.

References in the present disclosure to “one embodiment,” “an embodiment,” “an example embodiment,” and the like indicate that the embodiment described may include a particular feature, structure, or characteristic, but it is not necessary that every embodiment includes the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

It shall be understood that although the terms “first” and “second” etc. may be used herein to describe various elements, these elements should not be limited by these terms. These terms are only used to distinguish one element from another. For example, a first element could be termed a second element, and similarly, a second element could be termed a first element, without departing from the scope of example embodiments. As used herein, the term “and/or” includes any and all combinations of one or more of the listed terms.

The terminology used herein is for the purpose of describing particular embodiments only and is not intended to be limiting of example embodiments. As used herein, the singular forms “a”, “an” and “the” are intended to include the plural forms as well, unless the context clearly indicates otherwise. It will be further understood that the terms “comprises”, “comprising”, “has”, “having”, “includes” and/or “including”, when used herein, specify the presence of stated features, elements, and/or components etc., but do not preclude the presence or addition of one or more other features, elements, components and/or combinations thereof.

As used in this application, the term “circuitry” may refer to one or more or all of the following:
(a) hardware-only circuit implementations (such as implementations in only analog and/or digital circuitry) and
(b) combinations of hardware circuits and software, such as (as applicable):
   (i) a combination of analog and/or digital hardware circuit(s) with software/firmware and
   (ii) any portions of hardware processor(s) with software (including digital signal processor(s)), software, and memory(ies) that work together to cause an apparatus, such as a mobile phone or server, to perform various functions) and
(c) hardware circuit(s) and or processor(s), such as a microprocessor(s) or a portion of a microprocessor(s), that requires software (e.g., firmware) for operation, but the software may not be present when it is not needed for operation.

This definition of circuitry applies to all uses of this term in this application, including in any claims. As a further example, as used in this application, the term circuitry also covers an implementation of merely a hardware circuit or processor (or multiple processors) or portion of a hardware circuit or processor and its (or their) accompanying software and/or firmware. The term circuitry also covers, for example and if applicable to the particular claim element, a baseband integrated circuit or processor integrated circuit for a mobile device or a similar integrated circuit in server, a cellular network device, or other computing or network device.

As used herein, the term “communication network” refers to a network following any suitable communication standards, such as Long Term Evolution (LTE), LTE-Advanced (LTE-A), Wideband Code Division Multiple Access (WCDMA), High-Speed Packet Access (HSPA), Narrow Band Internet of Things (NB-IoT) and so on. Furthermore, the communications between a terminal device and a network device in the communication network may be performed according to any suitable generation communication protocols, including, but not limited to, the first generation (1G), the second generation (2G), 2.5G, 2.75G, the third generation (3G), the fourth generation (4G), 4.5G, the future fifth generation (5G) communication protocols, and/or any other protocols either currently known or to be developed in the future. Embodiments of the present disclosure may be applied in various communication systems. Given the rapid development in communications, there will of course also be future type communication technologies and systems with which the present disclosure may be embodied. It should not be seen as limiting the scope of the present disclosure to only the aforementioned system.

As used herein, the term “network device” refers to a node in a communication network via which a terminal device accesses the network and receives services therefrom. The network device may refer to a base station (BS) or an access point (AP), for example, a node B (NodeB or NB), an evolved NodeB (eNodeB or eNB), a NR NB (also referred to as a gNB), a Remote Radio Unit (RRU), a radio header (RH), a remote radio head (RRH), a relay, a low power node such as a femto, a pico, and so forth, depending on the applied terminology and technology.

The term “terminal device” refers to any end device that may be capable of wireless communication. By way of example rather than limitation, a terminal device may also be referred to as a communication device, user equipment (UE), a Subscriber Station (SS), a Portable Subscriber Station, a Mobile Station (MS), or an Access Terminal (AT). The terminal device may include, but not limited to, a mobile phone, a cellular phone, a smart phone, voice over IP (VoIP) phones, wireless local loop phones, a tablet, a wearable terminal device, a personal digital assistant (PDA), portable computers, desktop computer, image capture terminal devices such as digital cameras, gaming terminal devices, music storage and playback appliances, vehicle-mounted wireless terminal devices, wireless endpoints, mobile stations, laptop-embedded equipment (LEE), laptop-mounted equipment (LME), USB dongles, smart devices, wireless customer-premises equipment (CPE), an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. In the following description, the terms “terminal device”, “communication device”, “terminal”, “user equipment” and “UE” may be used interchangeably.

As used herein, the term “TRP” may refer to an antenna array (with one or more antenna elements) available to the network device located at a specific geographical location. For example, a network device may be coupled with multiple TRPs in different geographical locations to achieve better coverage. Alternatively or in addition, multi TRPs may be incorporated into a network device, or in other words, the network device may comprise the multi TRPs. It is to be understood that the TRP may also be referred to as a “panel”, which also refers to an antenna array (with one or more antenna elements) or a group of antennas. It is to also be understood that the TRP may refer to a logical concept which may be physically implemented by various manner.

As mentioned above, beam management is needed at the UE. The beam management usually comprises beam failure detection (BFD) and candidate beam detection (CBD). Generally, the UE performs BFD to detect when one or more physical downlink control channels (PDCCH) links are considered to be in failure conditions. When the UE detects a beam failure, the UE will perform CBD to detect a new potential beam called candidate beam. To better understand the principle and example embodiments of the present disclosure, a brief introduction to the BFD and CBD is now described below.

A network device may configure a terminal device with a set of reference signals (RSs) for monitoring the quality of the link. This set of RSs may be referred as Q₀ or beam failure detection RS (BFD-RS). Typically, BFD-RS(s) are configured to be spatially QCL'd with PDCCH demodulation reference signal (DMRS). That is, these RSs correspond to downlink beams used for PDCCH. Downlink beams are identified by RS, either synchronization signal (SS)/physical broadcast channel (PBCH) block (SSB) or channel state information-reference signal (CSI-RS).

Physical layer assesses the quality of the radio link based on BFD-RS in set of Q₀ periodically. Assessment is done per BFD-RS and when the radio link condition of each BFD-RS in the beam failure detection set is considered to be in failure condition, a beam failure instance (BFI) indication is provided to higher layer, for example, the MAC. Evaluation and indication may be done periodically.

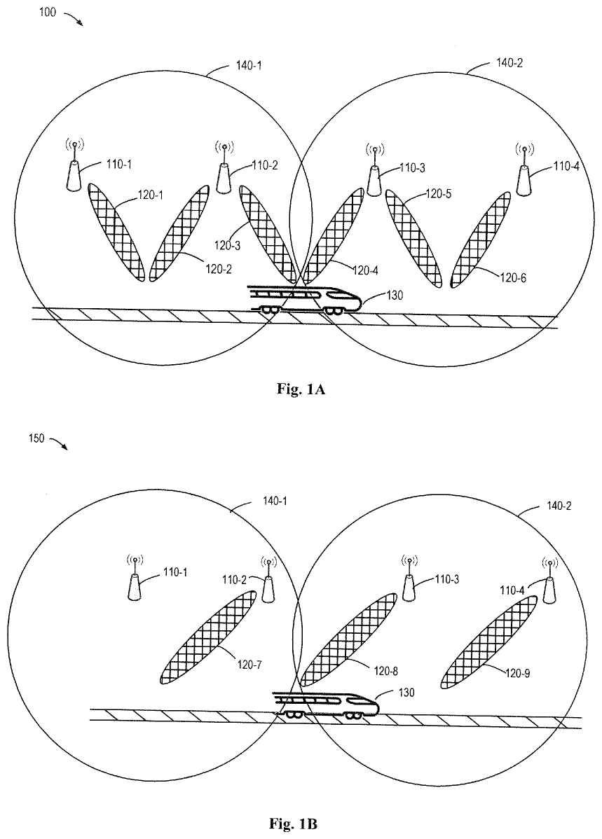

The UE may operate in a high-speed scenario. FIGS. 1A and 1B illustrate example deployments 100 and 150 for HST in Frequency Range (FR2). As shown in FIGS. 1A and 1B, a HST 130 and thus a UE located on the HST 130 may be traveling at a speed exceeding 350 km/h. A gNB (not shown) may be equipped with multiple TRP 110-1, TRP 110-2, TRP 110-3 and TRP 110-4, which may be spaced apart along a track on which the HST 130 is running. The TRP 110-1, TRP 110-2, TRP 110-3 and TRP 110-4A may be collectively referred to as “TRPs 110” or individually referred to as “TRP 110”. A distance between two neighboring TRPs 110 could be 800 meter, 650 meter, 500 meter, 300 meter or 200 meter for example. These TRPs 110 may belong to different cells 140-1 and 140-2, which may be collectively referred to as “cells 140” or individually referred to as “cell 140”. For example, TRP 110-1 and TRP 110-2 may belong to a cell 140-1, and TRP 110-3 and TRP 110-4 may belong to a cell 140-2. A distance between the cell 140 and the track could be 10 meter, 50 meter or 30 meter for example.

The TRPs 110 are configured to provide beams for communication with the UE via beams. In the bi-directional single frequency network (SFN) as shown in FIG. 1A, each TRP 110 can provide beams in two directions, for example beam 120-1, beam 120-2, beam 120-3, beam 120-4, beam 120-5, beam 120-6. In the unidirectional SFN as shown in FIG. 1B, each TRP 110 can provide beams in one direction, for example beam 120-7, beam 120-8, beam 120-9. The beams 120-1, 120-2, 120-3, 120-4, 120-5, 120-6 may be collectively referred to as “beams 120” or individually referred to as “beam 120”. When the HST 130 is located at a particular location of the track, the UE located on the HST 130 may receive signals from several TRPs 110 via different beams 120.

When communicating in high frequency bands, such as in FR2, the high speed of the HST 130 can result in Doppler shifts in signals received from a given TRP 110, which may be up to 2 Hz. This makes it very challenging for the UE to perform beam management. Therefore, there is needed for the UE to enhance beam management particularly in FR2 for HST.

According to embodiments of the present disclosure, there is proposed a solution for beam management, and in particular for beam management for HST in FR2. The exemplary embodiments describe beam management using a reduced evaluation period. When receiving from the network device a configuration concerning a high-speed mode of the terminal device, the terminal device determines a reduced evaluation period for beam management in the high-speed mode based on the configuration. The reduced evaluation period is shorter than an evaluation period in a non-high-speed mode. Then, the terminal device performs the beam management using the reduced evaluation period. In some embodiments, the terminal device may perform BFD and CBD in parallel. In some embodiments, RS configuration for CBD may be enhanced.

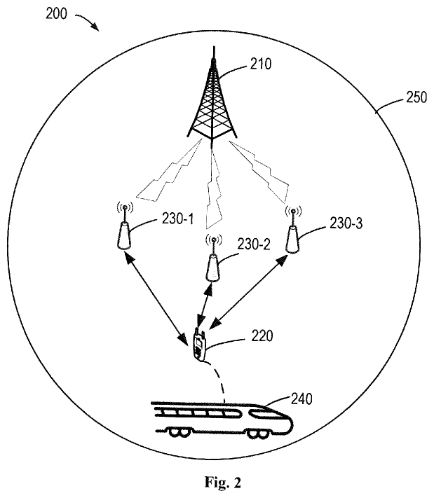

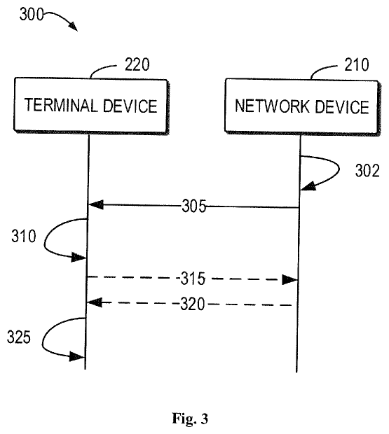

Principles and implementations of the present disclosure will be described in detail below with reference to FIGS. 2-8.

FIG. 2 shows an example communication network 200 in which embodiments of the present disclosure can be implemented. The network 200 includes a network device 210 and a terminal device 220 served by the network device 210. The network device 210 is coupled with three TRPs 230-1, 230-2 and 230-3, which may be collectively referred to as TRPs 230 or individually referred to as TRP 230. Each TRP 230 may use bi-directional SFN or unidirectional SFN in FR2 to transmit signals to the terminal device 220. The serving area of the network device 210 is called as a cell 250. It is to be understood that the number of network devices, terminal devices, cell and TRPs is only for the purpose of illustration without suggesting any limitations. The network 200 may include any suitable number of network devices, terminal devices, cells and TRPs adapted for implementing embodiments of the present disclosure. Although not shown, it is to be understood that one or more terminal devices may be located in the cell 250 and served by the network device 210.

In the communication network 200, the network device 210 can communicate data and control information to the terminal device 220 and the terminal device 220 can also communication data and control information to the network device 210. A link from the network device 210 to the terminal device 220 is referred to as a downlink (DL) or a forward link, while a link from the terminal device 220 to the network device 210 is referred to as an uplink (UL) or a reverse link.

As shown in FIG. 2, the network device 210 may communicate with the terminal device 220 via the TRPs 230-1, 230-2 and 230-3. The TRPs 230-1, 230-2 and 230-3 may be included in a same serving cell (such as, the cell 250 as shown in FIG. 2) or different serving cells provided by the network device 210.

Although some embodiments of the present disclosure are described with reference to the TRPs 230-1, 230-2 and 230-3 within a same serving cell 250 provided by the network device 210, these embodiments are only for the purpose of illustration and help those skilled in the art to understand and implement the present disclosure, without suggesting any limitations on the scope of the present disclosure. The embodiments of the present disclosure may be implemented in a network where the TRPs 230 are within different serving cells provided by the network device 210. It is to be understood that the present disclosure described herein can be implemented in various manners other than the ones described below.

The communications in the network 200 may conform to any suitable standards including, but not limited to, Long Term Evolution (LTE), LTE-Evolution, LTE-Advanced (LTE-A), Wideband Code Division Multiple Access (WCDMA), Code Division Multiple Access (CDMA) and Global System for Mobile Communications (GSM) and the like. Furthermore, the communications may be performed according to any generation communication protocols either currently known or to be developed in the future. Examples of the communication protocols include, but not limited to, the first generation (1G), the second generation (2G), 2.5G, 2.75G, the third generation (3G), the fourth generation (4G), 4.5G, the fifth generation (5G) communication protocols.

In some exemplary embodiments, the network device 210 is configured to implement beamforming techniques and transmit signals to the terminal device 220 via a plurality of beams. The terminal device 220 is configured to receive the signals transmitted by the network device 210 via the plurality of beams. For example, as shown in FIG. 2, each of the TRPs 230 may provide beam(s) for communication with the terminal device 220. The terminal device 220 may operate in a high-speed mode. The high-speed mode may be a mode in FR2 for HST. For example, the terminal device 220 may be located on a HST. Accordingly, beam management at the terminal device 220 is enhanced.

Reference is now made to reference to FIG. 3. FIG. 3 illustrates a flowchart illustrating an example process 300 for beam management according to some embodiments of the present disclosure. For the purpose of discussion, the process 300 will be described with reference to FIG. 2. The process 300 may involve the network device 210 and the terminal device 220 as illustrated in FIG. 2.

In the example process 300, the network device 210 determines 302 a configuration concerning beam management of the terminal device 220 in a high-speed mode. In some embodiments, the high-speed mode may be a mode in FR2 for IST.

The network device 210 transmits 305 the configuration to the terminal device 220. After the terminal device 220 receives the configuration, the terminal device determines 310 a reduced evaluation period for beam management in the high-speed mode based on the configuration. The reduced evaluation period determined by the terminal device 220 is shorter than an evaluation period in a non-high-speed mode, which may be referred to as “a normal evaluation period”.

In some embodiments, the terminal device 220 may determine whether the terminal device 220 is in a high mobility state based on the configuration. If the terminal device 220 determines that the terminal device 220 is in the high mobility state, then the terminal device 220 may determine the reduced evaluation period based on a scaling factor indicated in the configuration and the normal evaluation period. For example, the reduced evaluation period may be calculated by multiplying the normal evaluation period with the scaling factor. The normal evaluation period may be calculated by using any suitable method. In the following, a value of a parameter for determining the normal evaluation period is referred to as a “normal value” for the purpose of illustration.

To determine whether the terminal device 220 is in the high mobility state, in some embodiments, the terminal device 220 may determine whether a change of transmission configuration indicator (TCI) states over time exceeds a TCI state change threshold indicated in the configuration. If the change of TCI states over time exceeds the TCI state change threshold, then the terminal device 220 is in the high mobility state.

Alternatively or in addition, to determine whether the terminal device 220 is in the high mobility state, the terminal device 220 may determine whether a change of TRPs over time exceeds a TRP state change threshold indicated in the configuration. If the change of TRPs over time exceeds the TRP change threshold, then the terminal device 220 is in the high mobility state.

As an example, the configuration received from the network device 210 may be comprised in an information element “MobilityStateBeamManagement” as shown below:

MobilityStateBeamManagement :: = SEQUENCE {
T-evaluation ENUMBERATED {ms100, ms200, ms400, ms800, ms1600,
ms3200, ms6400},
n-TCIstateChange INTERGER {1, ... 16}
n-TRPChange INTERGER {1, ... 16}
EvaluationPeriodScalingfactor 1.0, 0.75, 0.5, 0.25}

The information element “MobilityStateBeamManagement” may comprise several fields, including “T-evaluation”, “n-TCIstateChange”, “n-TRPChange”, and “EvaluationPeriodScalingfactor” and so on. The field “T-evaluation” may specify several optional periods over which a change of TCI states or a change of TRPs is measured, such as 100 ms, 200 ms, 400 ms, 800 ms, 1600 ms, 3200 ms and 6400 ms as enumerated. The field “n-TClstateChange” may specify several optional TCI state change thresholds, such as 1, . . . 16. The terminal device 220 may determine whether a change of TCI states over a period indicated in the field “T-evaluation” exceeds a TCI state change threshold indicated in the “n-TCIstateChange” field. If the change of TCI states exceeds the TC state change threshold, then the terminal device 220 is in the high mobility state.

The field “n-TRPChange” may specify several optional TRP change thresholds, such as 1, . . . 16. The terminal device 220 may determine whether a change of TRPs over a period indicated in the field “T-evaluation” exceeds a TRP change threshold indicated in the “n-TRPChange” field. If the change of TPRs exceeds the TRP change threshold, then the terminal device 220 is in the high mobility state.

The field “EvaluationPeriodScalingfactor” may specify several optional scaling factors in the non-high-speed mode, such as 1.0, 0.75, 0.5, 0.25 as enumerated. If the terminal device 220 is in the high mobility state, the terminal device 220 may determine the reduced evaluation period based on the scaling factor indicated in the field “EvaluationPeriodScalingfactor”. For example, the reduced evaluation period may be calculated by multiplying the normal evaluation period with the scaling factor indicated in the field “EvaluationPeriodScalingfactor”. It is to be understood that the above values as shown in the information element “MobilityStateBeamManagement” are only for purpose of illustration without any limitation.

Alternatively or in addition, in some embodiments, the configuration received from the network device 210 may indicate that the high-speed mode is enabled for the terminal device 220. For example, if radio resource management (RRM) enhancement for high-speed is configured, then the terminal device 220 is enabled with the high-speed mode. If the terminal device 220 is enabled with the high-speed mode, the terminal device 220 may determine the reduced evaluation period based on at least one parameter corresponding to the high-speed mode. A value of the at least one parameter corresponding to the high-speed mode is smaller than a value of the at least one parameter corresponding to the non-high-speed mode. The at least one parameter corresponding to the non-high-speed mode may be determined by any using suitable method. Such embodiments will be further discussed below with respect to Tables 1, 3, 5 and 6.

Still referring to FIG. 3, after the terminal device 220 determines the reduced evaluation period for the beam management in the high-speed mode, the terminal device 220 performs 325 the beam management using the reduced evaluation period. The beam management may comprise BFD and CBD.

By reducing the evaluation period for BFD and CBD, the terminal device 220 can detect beam failure faster and detect candidate beams faster. In this way, the communication quality between the terminal device 220 and the network device 210 may be improved.

In some embodiments, the evaluation period for the BFD is at least partially overlapped with an evaluation period for the CBD in time. In other words, the terminal device 220 may perform the BFD and CBD in parallel.

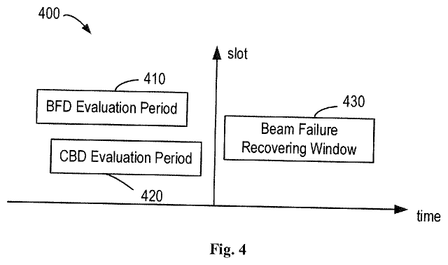

Reference is now made to FIG. 4, which shows a schematic diagram 400 illustrating an example parallel BFD and CBD according to some embodiments of the present disclosure. As shown in FIG. 4, the BFD evaluation period 410 is at least partially overlapped with the CBD evaluation period 420 in time. After the terminal device 220 reports the beam failure and the selected candidate beam to the network device 210, the terminal device 220 may perform the PDCCH Monitoring in beam failure recovery window 430.

Reference is now made back to FIG. 3. To perform BFD and CBD in parallel, the terminal device 220 may transmit 315 capability information to the network device 210. The capability information may indicate that the terminal device 220 has the capability to perform the BFD and the CBD in parallel. For example, the terminal device 220 may have two beam scan engines to perform the BFD and the CBD in parallel. The network device 210 may transmit 320 to the terminal device 220 an indication of performing the BFD and the CBD in parallel. Then, the terminal device 220 may perform the BFD and the CBD in parallel as illustrated in FIG. 4.

In such embodiments, by performing the BFD and CBD in parallel as shown in FIG. 4, the candidate beam can be selected almost at the same time when beam failure is detected. Therefore, it can reduce the waiting time for CBD as required in the conventional solution and thus improve the performance of radio link recovery. For the terminal device 220 located on a HST in FR2, faster BFD and CBD can potentially improve the overall communication quality between the terminal device 220 and the network device 210.

Due to the high moving speed of the terminal device 220, in some embodiments, the RS resource for CBD may be enhanced to include RSs from multiple TRPs. The terminal device 220 may receive a resource configuration from the network device 210. The resource configuration may indicate RSs to be used for the CBD. The RSs may comprise SSB, CSI-RS or a combination thereof. The RSs may be configured in different ways.

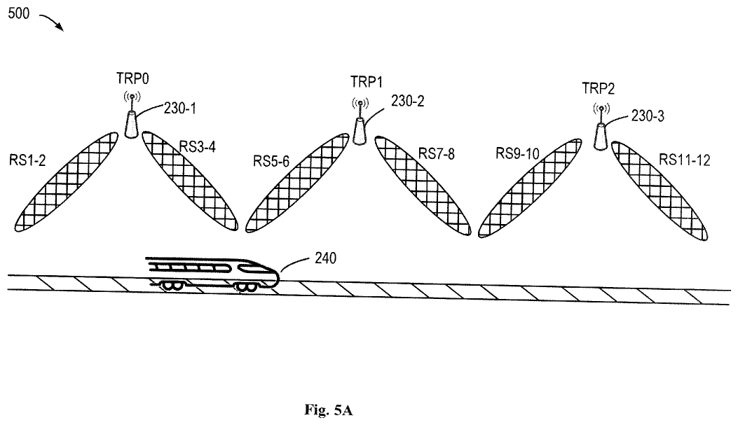

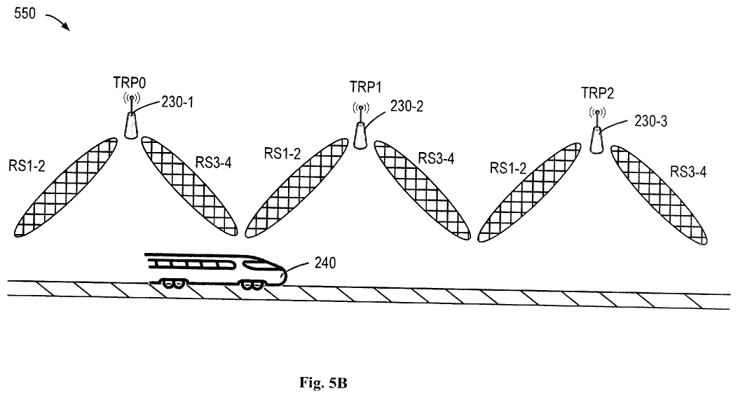

In some embodiments, different RS sets may be mapped to different TRPs within a serving cell of the terminal device 210. Reference is now made to FIG. 5A, which shows a schematic diagram 500 illustrating an example RS configuration for CBD according to some embodiments of the present disclosure. As shown in FIG. 5A, RSs 1-12 (the numerical value representing an index of the RS) are mapped to different TPRs 230 within the serving cell 250 of the terminal device 210. Specifically, the first RS set including RSs 1-4 is mapped to TRP 230-1, the second RS set including RSs 5-8 is mapped to TRP 230-2, and the third RS set including RSs 9-12 is mapped to TRP 230-3.

In such embodiments, the RSs are indexed across TRPs within the serving cell 250. In this case, the network device 210 can configure CBD RS across different TRPs based on RS index.

As an example, the resource configuration for SSB may be implemented as an information element illustrated as below:

BFR-SSB-Resource :: = {
ssb SSB-Index,
ra-PreambleIndex INTERGER (0..63),...}

In this example, the CBD SSB across different TRPs 230 can be configured by the network device 210 based on SSB-Index as indicated in the information element.

Alternatively, in some embodiments, a same RS set may be mapped to different TRPs within the serving cell 250 of the terminal device 210. Reference is now made to FIG. 5B, which show a schematic diagram illustrating an example RS configuration 550 for CBD according to some embodiments of the present disclosure. As shown in FIG. 5B, the same RS set including RSs 1-4 is mapped to TRP 230-1, TRP 230-2, and TRP 230-3.

In such embodiments, the RSs are indexed per TRP. In this case, the network device 210 may add TRP index in the resource configuration. As an example, the resource configuration may be implemented as an information element illustrated as below:

BFR-SSB-Resource :: = {
ssb SSB-Index,
Trp TRP-Index,
ra-PreambleIndex INTERGER (0..63),...}

In this example, the CBD SSBs are indexed per TRP 230. The CBD SSB index and the TRP index are configured by the network device 210 based on SSB-Index and TRP-Index as indicated in the information element.

Alternatively, in some embodiments, a same reference signal set may be mapped to all TRPs within the serving cell 250 of the terminal device 220. Still refer to FIG. 5B. For example, the same RS set including RSs 1-4 is mapped to all TRPs 230. In such embodiments, the RSs are indexed from all TRPs. In this case, the network device 210 may not need to add TRP index in the resource configuration. As an example, the resource configuration may be implemented as an information element illustrated as below:

BFR-SSB-Resource :: = {
ssb SSB-Index,
ra-PreambleIndex INTERGER (0..63),...}

In this example, the CBD SSBs are indexed from all TRPs. The CBD SSB index is configured by the network device 210 based on SSB-Index as indicated in the information element.

Still referring to FIG. 3, in some embodiments, when the beam management comprises the CBD, the process 300 may have additional actions. The terminal device 220 may receive a RRC message from the network device 210. The RRC message may indicate a plurality of RSs available for the CBD, such as RSs 1-64. The terminal device 220 may also receive a MAC CE from the network device 210. The MAC CE may indicate a subset of the plurality of RS to be used in the CBD, such as RS 1-8, RS 9-16, . . . , RS 56-63. In this way, the CBD resource index is dynamically triggered by the MAC CE.

As discussed above, in some embodiments, the configuration received from the network device 210 may indicate that the high-speed mode is enabled for the terminal device 220. If the terminal device 220 is enabled with the high-speed mode, the terminal device 220 may determine the reduced evaluation period based on at least one parameter corresponding to the high-speed mode. A value of the at least one parameter corresponding to the high-speed mode is smaller than a value of the at least one parameter corresponding to the non-high-speed mode.

Tables 1, 3, 5 and 6 below illustrate the calculation of the reduced evaluation period for CSI-RS based BFD, SSB based BFD, CSI-RS based CBD and SSB based CBD for FR2 in high-speed mode, respectively. The value of at least one parameter for Tables 1, 3, 5 and 6 is reduced as compared to the normal value.

Now refer to Table 1. Table 1 illustrates the calculation of the reduced evaluation period for CSI-RS based BFD for FR2 in high-speed mode. For FR2, the terminal device 220 may determine a reduced evaluation period T_{Evaluate_BFD_CSI-RS} for CSI-RS based BFD according to the following Table 1 based on the configuration concerning DRX from the network device 210 to achieve faster BFD.

TABLE 1
Reduced Evaluation period T_{Evaluate}_BFD_CSI-RS
with RRM enhancement for high speed (Frequency range FR2)

| Configuration | T_{Evaluate}_BFD_CSI-RS (ms) |
|---|---|
| No DRX | MAX(30, [M_{BFD} × P × |
| | N × P_{BFD}] × T_{CSI-RS}) |
| DRX | MAX(30, [ [symbol] × M_{BFD} × P × |
| cycle ≤320 ms | N × P_{BFD}] × MAX(T_{DRX}, T_{CSI-RS})) |
| DRX >320 ms | [M_{BFD} × P × N × |
| | P_{BFD}] × T_{DRX} |

Note:
T_{CSI-RS} is the periodicity of CSI-RS resource in the set q̅₀̅. T_{DRX} is the DRX cycle length.

In Table 1, M_{BFD} represents the number of L1 indications for the BFD. P represents a sharing factor. In this HST FR2 scenario, configurations from the network device 210 may ensure that the value of P is equal to 1, as the BFD-RS resource is not overlapped with measurement gap and also not overlapped with SMTC occasion. N represents the number of reception (Rx) beams used by the terminal device 220. The value of N is set to 1 in Table 1. P_{BFD} represents the sharing factor between different cells. The value of P_{BFD} is fixed to 1 in Table 1. MAX(X,Y) defines a maximum function which results in a maximum value of X and Y. T_{CSI-RS} is the periodicity of CSI-RS resource in the set q̅₀̅. T_{DRX} is the DRX cycle length.

In some embodiments, the at least one parameter for reducing the evaluation period for CSI-RS based BFD may comprise an element of the MAX function. The normal value of the element of the MAX function for CSI-RS based BFD in non-high-speed mode is 50 ms. By contrast, the value in Table 1 is reduced to 30 ms. Thus, the evaluation period for CSI-RS based BFD in high-speed mode is reduced for no DRX configuration and DRX cycle under 320 ms configuration.

Alternatively or in addition, the at least one parameter may comprise a scaling factor for DRX cycle of the terminal device 220 and Synchronization Signal/Physical Broadcast Channel block-based Measurement Timing Configuration (SMTC) periodicity. The normal value of scaling factor is 1.5. By contrast, in Table 1, the scaling factor for DRX cycle under 320 ms configuration is removed (i.e., the scaling factor is reduced to 1.0). Thus, the evaluation period for CSI-RS based BFD in high-speed mode is reduced for DRX cycle under 320 ms configuration.

Alternatively or in addition, the at least one parameter may comprise the number of L1 indications for the BFD (i.e., M_{BFD}). For example, the normal value of M_{BFD} is equal to 10 if the CSI-RS resource(s) in set q̅₀̅ used for BFD is transmitted with Density equal to 3. The value of M_{BFD} in Table 1 may be reduced to a smaller value, such as 5, to reduce the evaluation period. Alternatively, the value of M_{BFD} in Table 1 may be reduced to a smaller value under certain DRX cycle and SMTC periodicity combination. For example, when MAX(DRX cycle, SMTC period) is greater than a certain value, the value of M_{BFD} in Table 1 may be reduced to a smaller value, such as 5. Thus, the evaluation period for CSI-RS based BFD in high-speed mode is reduced.

By reducing the value of at least one of the above mentioned parameters in Table 1, the evaluation period for CSI-RS based BFD is reduced, thus enabling faster CSI-RS based BFD. With faster CSI-RS based BFD, the terminal device 220 can detect beam failure faster and more reliable. In this way, the communication quality between the terminal device 220 and the network device 210 can be improved.

The approach for reducing the evaluation period as discussed above with respect to Table 1 may also be applied to a radio link monitoring (RLM) evaluation period in a similar way.

Table 2 illustrates the calculation of reduced evaluation period for CSI-RS based RLM for FR2 in high-speed mode. Similarly, in Table 2, the value of parameters such as Mₒᵤₜ, Mᵢₙ, the scaling factor 1.5 and other possible parameters may be reduced. With reduced parameters, the terminal device 220 may perform faster CSI-RS based RLM.

TABLE 2
Reduced Evaluation period T_{Evaluate}_out_CSI-RS and T_{Evaluate}_in_CSI-RS
with RRM enhancement for high speed (Frequency range FR2)

| Configuration | T_{Evaluate}_out_CSI-RS (ms) | T_{Evaluate}_in_CSI-RS (ms) |
|---|---|---|
| No DRX | MAX(200, CEIL(Mₒᵤₜ × | MAX(100, CEIL(Mᵢₙ × |
| | P × N) × T_{CSI-RS}) | P × N) × T_{CSI-RS}) |
| DRX | MAX(200, CEIL(1.5 × | MAX(100, CEIL(1.5 × |
| cycle ≤320 ms | Mₒᵤₜ × P × N) × | Mᵢₙ × P × N) × |
| | MAX(T_{DRX}, T_{CSI-RS})) | MAX(T_{DRX}, T_{CSI-RS})) |
| DRX >320 ms | CEIL(Mₒᵤₜ × P × N) × | CEIL(Mᵢₙ × P × N) × |
| | T_{DRX} | T_{DRX} |

Note:
T_{CSI-RS} is the periodicity of the CSI-RS resource configured for RLM. The requirements in this table apply for T_{CSI-RS} equal to 5 ms, 10 ms, 20 ms or 40 ms. T_{DRX} is the DRX cycle length.

Table 3 illustrates the calculation of reduced evaluation period for SSB based BFD for FR2 in high-speed mode. For FR2, the terminal device 220 may determine a reduced evaluation period T_{Evaluate_BFD_SSB} for SSB-RS based BFD according to the following Table 3 based on the configuration concerning DRX from the network device 210.

TABLE 3
Reduced Evaluation period T_{Evaluate}_BFD_SSB with
RRM enhancement for high speed (Frequency range FR2)

| Configuration | T_{Evaluate}_BFD_SSB (ms) |
|---|---|
| No DRX | MAX(30, CEIL(3 × P × N) × T_{SSB}) |
| DRX | MAX(30, CEIL( [symbol] × 3 × |
| cycle ≤320 ms | P × N) × MAX(T_{DRX}, T_{SSB})) |
| DRX >320 ms | CEIL(3 × P × N) × T_{DRX} |

Note:
T_{SSB} is the periodicity of SSB resource in the set q̅₀̅. T_{DRX} is the DRX cycle length.

In Table 3, P represents a sharing factor. In this HST FR2 scenario, configurations from the network device 210 may ensure that the value of P is equal to 1, as the BFD-RS resource is not overlapped with measurement gap and also not overlapped with SMTC occasion. MAX(X, Y) defines a maximum function which results in a maximum value of X and Y. CEIL(X) defines a ceiling function which result in a smallest integer than is not smaller than X. T_{SSB} is the periodicity of SSB resource in the set T T_{DRX} is the DRX cycle length. The value of parameter P_{BFD} (not shown in Table 3) is equal to 1 as single carrier is employed in HST FR2 scenario.

Similar to CSI-RS based BFD, in some embodiments, for SSB based BFD, the at least one parameter which may be reduced to reduce the evaluation period for SSB based BFD may comprise an element of a MAX function. For example, the value of the element of the MAX function is reduced to a value (e.g., 30 ms) smaller than the normal value (e.g., 50 ms). The at least one parameter may also comprise a scaling factor for DRX cycle of the terminal device 220 and SMTC periodicity. For example, the scaling factor for DRX cycle under 320 ms configuration is removed, i.e., the scaling factor is reduced to 1.0 which is smaller than the normal value of 1.5.

Alternatively or in addition, the at least one parameter may comprise the number of L1 indications for the BFD (i.e., M_{BFD}). The value of M_{BFD} in Table 3 may be reduced to a smaller value, such as 3 (smaller than the normal value of 5) to reduce the evaluation period. Alternatively, the value of M_{BFD} in Table 3 may be reduced to a smaller value under certain DRX cycle and SMTC periodicity combination. For example, when MAX(DRX cycle, SMTC period) is greater than a certain value, the value of M_{BFD} in Table 3 may be reduced to a smaller value, such as 3.

Alternatively or in addition, the at least one parameter for SSB based BFD may further comprise the number of Rx beams used by the terminal device 220 (i.e., N). The normal value of N is fixed to 8. In Table 3, the value of N may be reduced to a value smaller than 8 based on a capability of the terminal device 220. By reducing the value of the above mentioned parameters, the evaluation period for SSB based BFD can be reduced, thus enabling faster BFD in FR2 HST scenario.

By reducing the value of at least one of the above mentioned parameters in Table 3, the evaluation period for SSB based BFD is reduced, thus enabling faster SSB based BFD. With faster SSB based BFD, the terminal device 220 can detect beam failure faster and more reliable. In this way, the communication quality between the terminal device 220 and the network device 210 can be improved.

The approach for reducing the evaluation period as discussed above with respect to Table 3 may also be applied to a RLM evaluation period in a similar way.

Table 4 illustrates the calculation of reduced evaluation period for SSB based RLM for FR2 in high-speed mode. Similarly, in Table 4, the value of parameters such as Mₒᵤₜ, Mᵢₙ, the scaling factor 1.5 and other possible parameters may be reduced. With reduced parameters, the terminal device 220 may perform faster SSB based RLM.

TABLE 4
Reduced Evaluation period T_{Evaluate}_out_SSB and T_{Evaluate}_in_SSB
with RRM enhancement for high speed (Frequency range FR2)

| Configuration | T_{Evaluate}_out_SSB (ms) | T_{Evaluate}_in_SSB (ms) |
|---|---|---|
| No DRX | MAX(200, CEIL(10 × | MAX(100, CEIL(5 × |
| | P × N) × T_{SSB}) | P × N) × T_{SSB}) |
| DRX | MAX(200, CEIL(1.5 × | MAX(100, CEIL(1.5 × |
| cycle ≤320 ms | Mₒᵤₜ × P × N) × | Mᵢₙ × P × N) × |
| | MAX(T_{DRX}, T_{CSI-RS})) | MAX(T_{DRX}, T_{CSI-RS})) |
| DRX >320 ms | CEIL(Mₒᵤₜ × P × | CEIL(Mᵢₙ × P × |
| | N) × T_{DRX} | N) × T_{DRX} |

Note:
T_{CSI-RS} is the periodicity of the CSI-RS resource configured for RLM. The requirements in this table apply for T_{CSI-RS} equal to 5 ms, 10 ms, 20 ms or 40 ms. T_{DRX} is the DRX cycle length.

Table 5 illustrates the calculation of reduced evaluation period for CSI-RS based CBD for FR2 in high-speed mode. For FR2, the terminal device 220 may determine a reduced evaluation period T_{Evaluate_CBD_CSI-RS} for CSI-RS based CBD according to the following Table 5 based on the configuration concerning DRX from the network device 210.

Now refer to Table 5. Table 5 illustrates the calculation of reduced evaluation period for CSI-RS based CBD for FR2 in high-speed mode. For FR2, the terminal device 220 may determine a reduced evaluation period T_{Evaluate_CBD_CSI-RS} for CSI-RS based CBD according to the following Table 5 based on the configuration concerning DRX from the network device 210.

TABLE 5
Reduced Evaluation period T_{Evaluate}_CBD_CSI-RS
with RRM enhancement for high speed (Frequency range FR2)

| Configuration | T_{Evaluate}_BFD_CSI-RS (ms) |
|---|---|
| No DRX, DRX | MAX(25, CEIL(M_{CBD} × P × |
| cycle ≤320 ms | N × P_{CBD}) × T_{CSI-RS}) |
| DRX >320 ms | CEIL(M_{CBD} × P × |
| | N × P_{CBD}) × T_{DRX} |

Note:
T_{CSI-RS} is the periodicity of CSI-RS resource in the set q̅₁. T_{DRX} is the DRX cycle length.

In Table 5, T_{CSI-RS} is the periodicity of CSI-RS resource in the set q̅₁̅. T_{DRX} is the DRX cycle length. M_{CBD} represents the number of measurements of CBD. P represents a sharing factor. In this HST FR2 scenario, configurations from the network device 210 may ensure that the value of P is equal to 1, as CBD RS is not overlapped with measurement gap and also not overlapped with SMTC occasion. The value of parameter P_{BFD} (not shown in Table 5) is equal to 1 as single carrier is employed in HST FR2 scenario. N represents the number of Rx beams used by the terminal device 220. MAX(X, Y) defines a maximum function which results in a maximum value of X and Y. CEIL(X) defines a ceiling function which result in a smallest integer than is not smaller than X.

In some embodiments, the at least one parameter for reducing the evaluation period for CSI-RS based CBD may comprise a scaling factor M_{CBD} for DRX cycle of the terminal device 220. The normal value of M_{CBD} is 3 for CSI-RS based CBD in non-high-speed mode, if the CSI-RS resource(s) configured in the set q̅₁̅ is transmitted with Density=3. By contrast, in Table 5, the scaling factor M_{CBD} can be reduced to a smaller value such as 2 or 1. Thus, the evaluation period for CSI-RS based CBD in high-speed mode is reduced. The at least one parameter may further comprise N. In Table 5, the value of N can be reduced to a value smaller than the normal value (e.g., 8), for example 4, based on the capability feedback of the terminal device 220.

By reducing the value of the at least one of the above mentioned parameters in Table 5, the evaluation period may be reduced to achieve faster CSI-RS based CBD. With faster SSB based CBD, the terminal device 220 can detect candidate beam faster and more reliable. In this way, the communication quality between the terminal device 220 and the network device 210 can be improved.

Table 6 illustrates the calculation of reduced evaluation period for SSB based CBD for FR2 in non-high-speed mode. For FR2, the terminal device 220 may determine a reduced evaluation period T_{Evaluate_BFD_SSB} for SSB based CBD according to the following Table 6 based on the configuration concerning DRX from the network device 210.

TABLE 6
Reduced Evaluation period T_{Evaluate}_BFD_SSB with
RRM enhancement for high speed (Frequency range FR2)

| Configuration | T_{Evaluate}_CBD_SSB (ms) |
|---|---|
| No DRX, DRX | MAX(25, CEIL(2 × P × |
| cycle ≤320 ms | N × P_{CBD}) × T_{SSB}) |
| DRX >320 ms | CEIL(2 × P × |
| | N × P_{CBD}) × T_{DRX} |

Note:
T_{SSB} is the periodicity of SSB in the set q̅₁. T_{DRX} is the DRX cycle length.

In Table 6, T_{SSB} is the periodicity of SSB resource in the set q̅₁̅. T_{DRX} is the DRX cycle length. In this HST FR2 scenario, configurations from the network device 210 may ensure that the value of P and the value of P_{CBD} are equal to 1, as SSB is not overlapped with measurement gap and also not overlapped with SMTC occasion. The value of parameter P_{BFD} (not shown in Table 6) is equal to 1 as single carrier is employed in HST FR2 scenario. N represents the number of Rx beams used by the terminal device 220. MAX(X, Y) defines a maximum function which results in a maximum value of X and Y. CEIL(X) defines a ceiling function which result in a smallest integer than is not smaller than X.

In some embodiments, similar to CSI-RS based CBD discussed above with respect to Table 5, the at least one parameter to reduce the evaluation period for SSB based CBD may comprise a scaling factor M_{CBD} for DRX cycle and SSB periodicity of the terminal device 220. The value of the scaling factor M_{CBD} in Table 6 can be reduced to a smaller value such as 2 (as shown in Table 6) or 1, while the normal value is equal to 3 for non-high-speed mode SSB based CBD. The at least one parameter may further comprise N. In Table 6, the value of N can be reduced to a value smaller than the normal value (e.g., 8) based on the capability feedback of the terminal device 220.

By reducing the value of the at least one of the above mentioned parameters in Table 6, the evaluation period may be reduced to achieve faster SSB based CBD. With faster SSB based CBD, the terminal device 220 can detect candidate beam faster and more reliable. In this way, the communication quality between the terminal device 220 and the network device 210 can be improved.

By the process 300 as illustrated with respect to FIGS. 3-5B above, the terminal device 220 may perform faster BFD and CBD. Thus, beam management is enhanced and the terminal device 220 can recover from the beam failure faster.

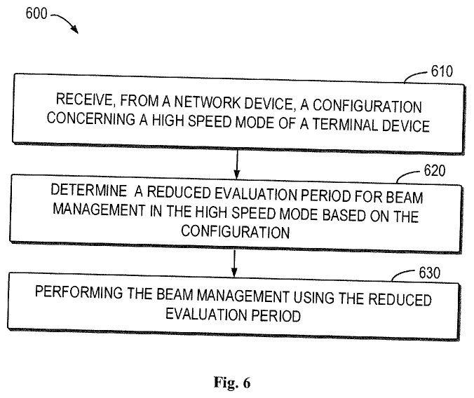

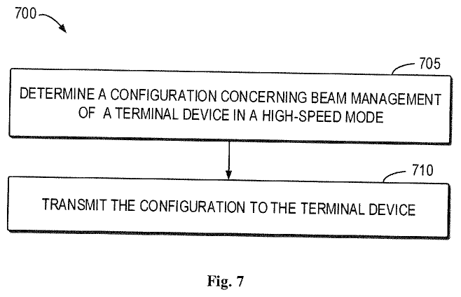

More details of the example embodiments in accordance with the present disclosure will be described with reference to FIGS. 6-7.

FIG. 6 shows a flowchart of an example method 600 of beam management performed by a terminal device according to some embodiments of the present disclosure. The method 600 can be implemented at a device e.g., at the terminal device 220 as shown in FIG. 2. For the purpose of discussion, the method 600 will be described with reference to FIG. 2. It is to be understood that the method 600 may include additional blocks not shown and/or may omit some shown blocks, and the scope of the present disclosure is not limited in this regard.

At block 610, the terminal device 220 receives a configuration concerning a high-speed mode of the terminal device from a network device 210. In some embodiments, the high-speed mode may comprise a mode in FR2 for IST.

At block 620, the terminal device 220 determines a reduced evaluation period for beam management in the high-speed mode based on the configuration received from the network device 210. The reduced evaluation period is shorter than an evaluation period in a non-high-speed mode.

In some embodiments, the terminal device 220 may determine whether the terminal device 220 is in a high mobility state based on the configuration. If the terminal device 220 is in the high mobility state, the terminal device 220 may determine the reduced evaluation period based on a scaling factor indicated in the configuration and the evaluation period in the non-high-speed mode.

In some embodiments, if a change of TCI states over time exceeds a TCI state change threshold indicated in the configuration, the terminal device 220 may determine that the terminal device 220 is in the high mobility state. Alternatively, if a change of TRPs over time exceeds a TRP change threshold indicated in the configuration, the terminal device 220 may determine that the terminal device 220 is in the high mobility state.

In some embodiments, if the configuration indicates that the high-speed mode is enabled for the terminal device 220, the terminal device 220 may determine the reduced evaluation period based on at least one parameter corresponding to the high-speed mode. A value of the at least one parameter corresponding to the high-speed mode is smaller than a value of the at least one parameter corresponding to the non-high-speed mode.

At block 630, the terminal device 220 performs the beam management using the reduced evaluation period.

In some embodiments, the beam management may comprise CBD and at least one parameter may comprise at least one of: a scaling factor for DRX cycle of the terminal device 220 and a periodicity of a reference signal which the CBD is based on, or the number of Rx beams used by the terminal device 220.

In some embodiments, the beam management may comprise BFD and the at least one parameter may comprise at least one of: a scaling factor for DRX cycle of the terminal device and SMTC periodicity, the number of L1 indications for the BFD, an element of a MAX function, or the number of Rx beams used by the terminal device 220.

In some embodiments, the beam management may comprise BFD and CBD and an evaluation period for the BFD may be at least partially overlapped with an evaluation period for the CBD in time.

In some embodiments, the terminal device 220 may transmit, to the network device 210, capability information indicating a capability of the terminal device 220 to perform the BFD and the CBD in parallel. The terminal device 220 may receive, from the network device 210, an indication of performing the BFD and the CBD in parallel.

In some embodiments, the beam management may comprise CBD. The terminal device 220 may receive, from the network device 210, a further configuration indicating reference signals to be used for the CBD. The further configuration may indicate that different reference signal sets are mapped to different TRPs within a serving cell of the terminal device 220. Alternatively, the further configuration may indicate that a same reference signal set is mapped to different TRPs within a serving cell of the terminal device 220. Alternatively, the further configuration may indicate that a same reference signal set is mapped to all TRPs within a serving cell of the terminal device 220.

In some embodiments, the beam management may comprise CBD. The terminal device 220 may receive, from the network device 210, a RRC message indicating a plurality of reference signals available for the CBD. The terminal device 220 may receive, from the network device 210, a MAC CE indicating a subset of the plurality of reference signals to be used in the CBD.

FIG. 7 shows a flowchart of an example method 700 of beam management configuration performed by a network device according to some embodiments of the present disclosure. The method 700 can be implemented at a device e.g., at the network device 210 as shown in FIG. 2. For the purpose of discussion, the method 700 will be described with reference to FIG. 2. It is to be understood that the method 700 may include additional blocks not shown and/or may omit some shown blocks, and the scope of the present disclosure is not limited in this regard.

At block 705, the network device 210 determines a configuration concerning beam management of a terminal device 220 in a high-speed mode. At block 710, the network device 210 transmits the configuration to the terminal device 220. As such, beam management in the high-speed mode is performed by the terminal device 220 using a reduced evaluation period determined based on the configuration. The reduced evaluation period is shorter than an evaluation period in a non-high-speed mode. In some embodiments, the high-speed mode may comprise a mode in FR2 for HST.

In some embodiments, the configuration may indicate a scaling factor to be used by the terminal device 220 to determine the reduced evaluation period.

In some embodiments, the configuration may indicate at least one of: a TCI state change threshold to be used by the terminal device 220 to compare with a change of TCI states over time, or a TRP change threshold to be used by the terminal device 220 to compare with a change of TRPs over time.

In some embodiments, the configuration may indicate that the high-speed mode is enabled for the terminal device 220.

In some embodiments, the network device 210 may receive from the terminal device 220, capability information indicating a capability of the terminal device 220 to perform BFD and CBD in parallel.

In some embodiments, the network device 210 may transmit to the terminal device 220, an indication of performing the BFD and the CBD in parallel.

In some embodiments, the beam management may comprise CBD and the network device 210 may transmit, to the terminal device 220, a further configuration indicating reference signals to be used for the CBD. The further configuration may indicate that different reference signal sets are mapped to different TRPs within a serving cell of the terminal device 220. Alternatively, the further configuration may indicate that a same reference signal set is mapped to different TRPs within a serving cell of the terminal device 220. Alternatively, the further configuration may indicate that a same reference signal set is mapped to all TRPs within a serving cell of the terminal device 220.

In some embodiments, the beam management may comprise CBD and the network device 210 may transmit, to the terminal device 220, a RRC message indicating a plurality of reference signals available for the CBD; and transmit, to the terminal device 220, a MAC CE indicating a subset of the plurality of reference signals to be used in the CBD.

In some embodiments, an apparatus capable of performing the method 600 may comprise means for performing the respective steps of the method 600. The means may be implemented in any suitable form. For example, the means may be implemented in a circuitry or software module.

In some embodiments, the apparatus capable of performing the method 600 comprises: means for receiving, at a terminal device from a network device, a configuration concerning a high-speed mode of the terminal device; means for determining a reduced evaluation period for beam management in the high-speed mode based on the configuration, the reduced evaluation period shorter than an evaluation period in a non-high-speed mode; and means for performing the beam management using the reduced evaluation period.

In some embodiments, the high-speed mode comprises a mode in FR2 for a high-speed train.

In some embodiments, the means for determining the reduced evaluation period based on the configuration comprises: means for determining whether the terminal device is in a high mobility state based on the configuration; and means for in accordance with a determination that the terminal device is in the high mobility state, determining the reduced evaluation period based on a scaling factor indicated in the configuration and the evaluation period in the non-high-speed mode.

In some embodiments, the means for determining whether the terminal device is in the high mobility state based on the configuration comprises at least one of: means for in accordance with a determination that a change of TC states over time exceeds a TCI state change threshold indicated in the configuration, determining that the terminal device is in the high mobility state; or means for in accordance with a determination that a change of TRPs over time exceeds a TRP change threshold indicated in the configuration, determining that the terminal device is in the high mobility state.

In some embodiments, the means for determining the reduced evaluation period based on the configuration comprises: means for in accordance with a determination that the configuration indicates that the high-speed mode is enabled for the terminal device, determining the reduced evaluation period based on at least one parameter corresponding to the high-speed mode, a value of the at least one parameter corresponding to the high-speed mode smaller than a value of the at least one parameter corresponding to the non-high-speed mode.

In some embodiments, the beam management comprises CBD and at least one parameter comprises at least one of: a scaling factor for DRX cycle of the terminal device and a periodicity of a reference signal which the CBD is based on, or the number of reception beams used by the terminal device.

In some embodiments, the beam management comprises BFD and the at least one parameter comprises at least one of: a scaling factor for DRX cycle of the terminal device and SMTC periodicity, the number of L1 indications for the BFD, an element of a MAX function, or the number of reception beams used by the terminal device.

In some embodiments, the beam management comprises BFD and CBD and an evaluation period for the BFD is at least partially overlapped with an evaluation period for the CBD in time.

In some embodiments, the apparatus capable of performing the method 600 further comprises: means for transmitting, to the network device, capability information indicating a capability of the terminal device to perform the BFD and the CBD in parallel; and means for receiving, from the network device, an indication of performing the BFD and the CBD in parallel.

In some embodiments, the beam management comprises CBD and the apparatus capable of performing the method 600 further comprises: means for receiving, from the network device, a further configuration indicating reference signals to be used for the CBD, the further configuration indicating one of: that different reference signal sets are mapped to different TRPs within a serving cell of the terminal device, that a same reference signal set is mapped to different TRPs within a serving cell of the terminal device, or that a same reference signal set is mapped to all TRPs within a serving cell of the terminal device.

In some embodiments, the beam management comprises CBD and the apparatus capable of performing the method 600 further comprises: means for receiving, from the network device, a RRC message indicating a plurality of reference signals available for the CBD; and receiving, from the network device, a MAC CE indicating a subset of the plurality of reference signals to be used in the CBD.

In some embodiments, an apparatus capable of performing the method 700 may comprise means for performing the respective steps of the method 700. The means may be implemented in any suitable form. For example, the means may be implemented in a circuitry or software module.

In some embodiments, the apparatus capable of performing the method 700 comprises: means for determining, at a network device, a configuration concerning beam management of a terminal device in a high-speed mode; and means for transmitting the configuration to the terminal device, such that the beam management in the high-speed mode is performed by the terminal device using a reduced evaluation period determined based on the configuration, the reduced evaluation period shorter than an evaluation period in a non-high-speed mode.

In some embodiments, the high-speed mode comprises a mode in FR2 for HST.

In some embodiments, the configuration indicates a scaling factor to be used by the terminal device to determine the reduced evaluation period.

In some embodiments, the configuration indicates at least one of: a TCI state change threshold to be used by the terminal device to compare with a change of TCI states over time, or a TRP change threshold to be used by the terminal device to compare with a change of TRPs over time.

In some embodiments, the configuration indicates that the high-speed mode is enabled for the terminal device.

In some embodiments, the apparatus capable of performing the method 700 further comprises: means for receiving, from the terminal device, capability information indicating a capability of the terminal device to perform BFD and CBD in parallel; and means for transmitting, to the terminal device, an indication of performing the BFD and the CBD in parallel.

In some embodiments, the beam management comprises CBD and the apparatus capable of performing the method 700 further comprises: means for transmitting, to the terminal device, a further configuration indicating reference signals to be used for the CBD, the further configuration indicating one of: that different reference signal sets are mapped to different TRPs within a serving cell of the terminal device, that a same reference signal set are mapped to different TRPs within a serving cell of the terminal device, or that a same reference signal set are mapped to all TRPs within a serving cell of the terminal device.

In some embodiments, the beam management comprises CBD and the apparatus capable of performing the method 700 further comprises: means for transmitting, to the terminal device, a RRC message indicating a plurality of reference signals available for the CBD; and transmitting, to the terminal device, a MAC CE indicating a subset of the plurality of reference signals to be used in the CBD.

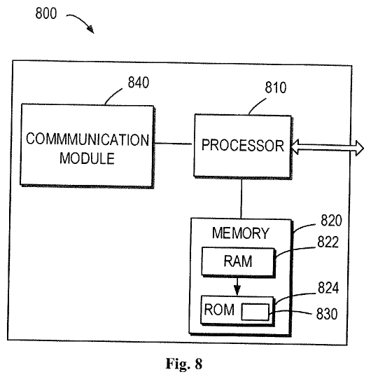

FIG. 8 is a simplified block diagram of a device 800 that is suitable for implementing embodiments of the present disclosure. The device 800 may be provided to implement the communication device, for example the terminal devices 220 or the network device 210 as shown in FIG. 2. As shown, the device 800 includes one or more processors 810, one or more memories 820 coupled to the processor 810, and one or more communication modules 840 coupled to the processor 810.

The communication module 840 is for bidirectional communications. The communication module 840 has at least one antenna to facilitate communication. The communication interface may represent any interface that is necessary for communication with other network elements.

The processor 810 may be of any type suitable to the local technical network and may include one or more of the following: general purpose computers, special purpose computers, microprocessors, digital signal processors (DSPs) and processors based on multicore processor architecture, as non-limiting examples. The device 800 may have multiple processors, such as an application specific integrated circuit chip that is slaved in time to a clock which synchronizes the main processor.

The memory 820 may include one or more non-volatile memories and one or more volatile memories. Examples of the non-volatile memories include, but are not limited to, a Read Only Memory (ROM) 824, an electrically programmable read only memory (EPROM), a flash memory, a hard disk, a compact disc (CD), a digital video disk (DVD), and other magnetic storage and/or optical storage. Examples of the volatile memories include, but are not limited to, a random access memory (RAM) 822 and other volatile memories that will not last in the power-down duration.

A computer program 830 includes computer executable instructions that are executed by the associated processor 810. The program 830 may be stored in the ROM 820. The processor 810 may perform any suitable actions and processing by loading the program 830 into the RAM 820.

The embodiments of the present disclosure may be implemented by means of the program 830 so that the device 800 may perform any process of the disclosure as discussed with reference to FIGS. 6 to 7. The embodiments of the present disclosure may also be implemented by hardware or by a combination of software and hardware.

In some embodiments, the program 830 may be tangibly contained in a computer readable medium which may be included in the device 800 (such as in the memory 820) or other storage devices that are accessible by the device 800. The device 800 may load the program 830 from the computer readable medium to the RAM 822 for execution. The computer readable medium may include any types of tangible non-volatile storage, such as ROM, EPROM, a flash memory, a hard disk, CD, DVD, and the like. The computer readable medium has the program 830 stored thereon.

Generally, various embodiments of the present disclosure may be implemented in hardware or special purpose circuits, software, logic or any combination thereof. Some aspects may be implemented in hardware, while other aspects may be implemented in firmware or software which may be executed by a controller, microprocessor or other computing device. While various aspects of embodiments of the present disclosure are illustrated and described as block diagrams, flowcharts, or using some other pictorial representations, it is to be understood that the block, apparatus, system, technique or method described herein may be implemented in, as non-limiting examples, hardware, software, firmware, special purpose circuits or logic, general purpose hardware or controller or other computing devices, or some combination thereof.

The present disclosure also provides at least one computer program product tangibly stored on a non-transitory computer readable storage medium. The computer program product includes computer-executable instructions, such as those included in program modules, being executed in a device on a target real or virtual processor, to carry out the method 600 or 700 as described above with reference to FIGS. 6-7. Generally, program modules include routines, programs, libraries, objects, classes, components, data structures, or the like that perform particular tasks or implement particular abstract data types. The functionality of the program modules may be combined or split between program modules as desired in various embodiments. Machine-executable instructions for program modules may be executed within a local or distributed device. In a distributed device, program modules may be located in both local and remote storage media.

Program code for carrying out methods of the present disclosure may be written in any combination of one or more programming languages. These program codes may be provided to a processor or controller of a general purpose computer, special purpose computer, or other programmable data processing apparatus, such that the program codes, when executed by the processor or controller, cause the functions/operations specified in the flowcharts and/or block diagrams to be implemented. The program code may execute entirely on a machine, partly on the machine, as a stand-alone software package, partly on the machine and partly on a remote machine or entirely on the remote machine or server.

In the context of the present disclosure, the computer program codes or related data may be carried by any suitable carrier to enable the device, apparatus or processor to perform various processes and operations as described above. Examples of the carrier include a signal, computer readable medium, and the like.

The computer readable medium may be a computer readable signal medium or a computer readable storage medium. A computer readable medium may include but not limited to an electronic, magnetic, optical, electromagnetic, infrared, or semiconductor system, apparatus, or device, or any suitable combination of the foregoing. More specific examples of the computer readable storage medium would include an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing.

Further, while operations are depicted in a particular order, this should not be understood as requiring that such operations be performed in the particular order shown or in sequential order, or that all illustrated operations be performed, to achieve desirable results. In certain circumstances, multitasking and parallel processing may be advantageous. Likewise, while several specific implementation details are contained in the above discussions, these should not be construed as limitations on the scope of the present disclosure, but rather as descriptions of features that may be specific to particular embodiments. Certain features that are described in the context of separate embodiments may also be implemented in combination in a single embodiment. Conversely, various features that are described in the context of a single embodiment may also be implemented in multiple embodiments separately or in any suitable sub-combination.

Although the present disclosure has been described in languages specific to structural features and/or methodological acts, it is to be understood that the present disclosure defined in the appended claims is not necessarily limited to the specific features or acts described above. Rather, the specific features and acts described above are disclosed as example forms of implementing the claims.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

1. A method comprising:
receiving, at a terminal device from a network device, a configuration concerning a high-speed mode of the terminal device;
determining a reduced evaluation period for beam management in the high-speed mode based on the configuration, the reduced evaluation period shorter than an evaluation period in a non-high-speed mode; and
performing the beam management using the reduced evaluation period.

2. The method of claim 1, wherein the high-speed mode comprises a mode in Frequency Range 2 for a high-speed train.

3. The method of claim 1, wherein determining the reduced evaluation period based on the configuration comprising:
determining whether the terminal device is in a high mobility state based on the configuration; and
in accordance with a determination that the terminal device is in the high mobility state, determining the reduced evaluation period based on a scaling factor indicated in the configuration and the evaluation period in the non-high-speed mode.

4. The method of claim 3, wherein determining whether the terminal device is in the high mobility state based on the configuration comprising at least one of:
in accordance with a determination that a change of transmission configuration indicator (TCI) states over time exceeds a TCI state change threshold indicated in the configuration, determining that the terminal device is in the high mobility state, or
in accordance with a determination that a change of transmission reception points (TRPs) over time exceeds a TRP change threshold indicated in the configuration, determining that the terminal device is in the high mobility state.

5. The method of claim 1, wherein determining the reduced evaluation period based on the configuration comprising:
in accordance with a determination that the configuration indicates that the high-speed mode is enabled for the terminal device, determining the reduced evaluation period based on at least one parameter corresponding to the high-speed mode, a value of the at least one parameter corresponding to the high-speed mode smaller than a value of the at least one parameter corresponding to the non-high-speed mode.

6. The method of claim 5, wherein the beam management comprises candidate beam detection (CBD) and at least one parameter comprises at least one of:
a scaling factor for Discontinuous Reception (DRX) cycle of the terminal device and a periodicity of a reference signal which the CBD is based on, or
the number of reception beams used by the terminal device.

7. The method of claim 5, wherein the beam management comprises beam failure detection (BFD) and the at least one parameter comprises at least one of:
a scaling factor for DRX cycle of the terminal device and Synchronization Signal/Physical Broadcast Channel block-based Measurement Timing Configuration (SMTC) periodicity,
the number of L1 indications for the BFD,
an element of a MAX function, or
the number of reception beams used by the terminal device.

8. The method of claim 1, wherein the beam management comprises BFD and CBD and an evaluation period for the BFD is at least partially overlapped with an evaluation period for the CBD in time.

9. The method of claim 8, further comprising:
transmitting, to the network device, capability information indicating a capability of the terminal device to perform the BFD and the CBD in parallel; and
receiving, from the network device, an indication of performing the BFD and the CBD in parallel.

10. The method of claim 1, wherein the beam management comprises CBD and the method further comprises:
receiving, from the network device, a further configuration indicating reference signals to be used for the CBD, the further configuration indicating one of:
that different reference signal sets are mapped to different TRPs within a serving cell of the terminal device,
that a same reference signal set is mapped to different TRPs within a serving cell of the terminal device, or
that a same reference signal set is mapped to all TRPs within a serving cell of the terminal device.

11. The method of claim 1, wherein the beam management comprises CBD and the method further comprises:
receiving, from the network device, a radio resource control (RRC) message indicating a plurality of reference signals available for the CBD; and
receiving, from the network device, a medium access control (MAC) control element (CE) indicating a subset of the plurality of reference signals to be used in the CBD.

12. A method comprising:
determining, at a network device, a configuration concerning beam management of a terminal device in a high-speed mode; and
transmitting the configuration to the terminal device, such that the beam management in the high-speed mode is performed by the terminal device using a reduced evaluation period determined based on the configuration, the reduced evaluation period shorter than an evaluation period in a non-high-speed mode.

13. The method of claim 12, wherein the high-speed mode comprises a mode in Frequency Range 2 for a high-speed train.

14. The method of claim 12, wherein the configuration indicates a scaling factor to be used by the terminal device to determine the reduced evaluation period.

15. The method of claim 14, wherein the configuration indicates at least one of:
a transmission configuration indicator (TCI) state change threshold to be used by the terminal device to compare with a change of TCI states over time, or
a transmission reception point (TRP) change threshold to be used by the terminal device to compare with a change of TRPs over time.

16. The method of claim 12, wherein the configuration indicates that the high-speed mode is enabled for the terminal device.

17. The method of claim 12, further comprising:
receiving, from the terminal device, capability information indicating a capability of the terminal device to perform beam failure detection (BFD) and candidate beam detection (CBD) in parallel; and
transmitting, to the terminal device, an indication of performing the BFD and the CBD in parallel.

18. The method of claim 12, wherein the beam management comprises CBD and the method further comprises:
transmitting, to the terminal device, a further configuration indicating reference signals to be used for the CBD, the further configuration indicating one of:
that different reference signal sets are mapped to different TRPs within a serving cell of the terminal device,
that a same reference signal set are mapped to different TRPs within a serving cell of the terminal device, or
that a same reference signal set are mapped to all TRPs within a serving cell of the terminal device.

19. The method of claim 12, wherein the beam management comprises CBD and the method further comprises:
transmitting, to the terminal device, a radio resource control (RRC) message indicating a plurality of reference signals available for the CBD; and
transmitting, to the terminal device, a medium access control (MAC) control element (CE) indicating a subset of the plurality of reference signals to be used in the CBD.

20. A baseband processor of a terminal device configured to
receive a configuration concerning a high-speed mode of the terminal device:
determine a reduced evaluation period for beam management in the high-speed mode based on the configuration, the reduced evaluation period shorter than an evaluation period in a non-high-speed mode; and
perform the beam management using the reduced evaluation period.

21-25. (canceled)
